(19) United States
(12) Patent Application Publication
(10) Pub. No.: US 2022/0023792 A1
(43) Pub. Date: Jan. 27, 2022

(54) HONEYCOMB BODIES HAVING AN ARRAY OF CHANNELS WITH DIFFERENT HYDRAULIC DIAMETERS AND METHODS OF MAKING THE SAME

(71) Applicant: CORNING INCORPORATED, Corning, NY (US)

(72) Inventors: Douglas Munroe Beall, Painted Post, NY (US); Pushkar Tandon, Painted Post, NY (US)

(21) Appl. No.: 17/294,069

(22) PCT Filed: Nov. 6, 2019
(86) PCT No.: PCT/US2019/060004

§ 371 Date: May 14, 2021

Related U.S. Application Data
(60) Provisional application No. 62/768,380, filed on Nov. 16, 2018.

(51) Int. Cl. B01D 46/24; B01D 53/94; B01J 35/04

(52) U.S. Cl. CPC B01D 46/2474; F01N 3/2803; B01D 46/24491; B01D 46/24492; B01D 46/2484; B01D 46/2459; B01D 46/247; B01D 53/94; B01D 46/249; B01D 46/2494; B01D 46/2488; B01J 35/04; B01D 2255/9202; B01D 2255/9205; B01D 2255/9155; B01D 46/2482

(57) ABSTRACT

A honeycomb body comprises a matrix of intersecting porous walls forming channels. Plugs are disposed in a percentage of the channels having the second hydraulic diameter, wherein the percentage of the channels of the second diameter having a plug is less than or equal to 15%. In some embodiments, some of the channels have a first hydraulic diameter and others have a second hydraulic diameter that is smaller than the first hydraulic diameter, and may be unplugged for plugged. The porous walls can further comprise a transverse thickness of the walls Tw less than or equal to 0.20 mm, a channel density CD greater than or equal to 62 channels per cm², an average bulk porosity % P greater than or equal to 50%, and a median pore diameter d₅₀ ranging from between 4.0 μm and 30.0 μm.

This application claims the benefit of priority under 35 U.S.C. § 119 of U.S. Provisional Application Ser. No. 62/768,380 filed on Nov. 16, 2018, the content of which is incorporated herein by reference in its entirety.

### FIELD

The present disclosure relates to honeycomb bodies, and more particularly to honeycomb bodies comprising an array of channels and methods of manufacturing such honeycomb bodies.

### BACKGROUND

Ceramic honeycomb designs with relatively thin wall thickness can be utilized in exhaust after-treatment systems.

### SUMMARY

Embodiments of the present disclosure provide honeycomb bodies, such as partially plugged honeycomb bodies with improved gas flow through the wall and exhibiting low back pressure.

Embodiments of the present disclosure also provide methods of manufacturing porous honeycomb bodies comprising channels comprising different hydraulic diameters and that are partially plugged.

Embodiments of the present disclosure also provide honeycomb bodies comprising channels comprising different hydraulic diameters and further comprising partially plugged and unplugged honeycomb bodies comprising a catalyst disposed in the channels.

Embodiments of the present disclosure also provide honeycomb bodies, such as plugged honeycomb bodies comprising channels of large and small hydraulic diameters wherein a small percentage of the small channels are plugged and also comprising a catalyst disposed in the channels.

Embodiments of the present disclosure also provide honeycomb bodies, such as plugged honeycomb bodies comprising first channels and second channels, and wherein greater than zero and less than or equal to 15 percent of the second channels comprise plugs.

Embodiments of the present disclosure also provide honeycomb bodies, such as plugged honeycomb bodies comprising a first channels and second channels wherein the first channels comprise a first hydraulic diameter and the second channels comprise a second hydraulic diameter, wherein the second hydraulic diameter is smaller than the first hydraulic diameter, and greater than zero and less than or equal to 15 percent of the second channels comprise plugs.

In some example embodiments, a honeycomb body is provided comprising a matrix of intersecting porous walls forming first channels and second channels, the combination of first channels and second channels comprising a channel density, the first channels having a first hydraulic diameter and the second channels having a second hydraulic diameter, the second hydraulic diameter being smaller than the first hydraulic diameter; and plugs disposed in a percentage of the second channels, wherein the percentage of the second channels with plugs is greater than zero and less than or equal to 15%, and the intersecting porous walls further comprise:
Tw≤0.20 mm,
CD≥62 channels per cm²,
% P≥50%, and
4.0 μm≤d₅₀≤30.0 μm,

wherein Tw is a transverse wall thickness, CD is a channel density, % P is an average bulk porosity, and d₅₀ is a median pore diameter.

In another example embodiment of this disclosure, a catalyzed honeycomb body is provided comprising a matrix of intersecting porous walls forming first channels and second channels; and plugs disposed in a percentage of the second channels at an outlet end, the percentage of the second channels comprising plugs is greater than zero and less than or equal to 15%, and wherein the intersecting porous walls further comprise:
Tw≤0.20 mm,
CD≥62 channels per cm²,
% P≥50%, and
4.0 μm≤d₅₀≤30.0 μm,

wherein Tw is a transverse wall thickness, CD is a channel density, % P is an average bulk porosity, and d₅₀ is a median pore diameter; and a catalyst disposed the porous walls of the first channels and the second channels. In some embodiments, the first channels can comprise a first hydraulic diameter, and the second channels can comprise a second hydraulic diameter, wherein the second hydraulic diameter is smaller than the first hydraulic diameter.

In another example embodiment of this disclosure, a catalyzed honeycomb body is provided comprising a matrix of intersecting porous walls forming first channels and second channels, each first channel having a first hydraulic diameter, and each second channel having a second hydraulic diameter, wherein the second hydraulic diameter is smaller than the first hydraulic diameter; and plugs disposed in a percentage of the second channels, the percentage of the second channels comprising plugs is less than or equal to 15%, and wherein the intersecting porous walls further comprise:
Tw≤0.20 mm,
CD≥62 channels per cm²,
% P≥50%, and
4.0 μm≤d₅₀≤30.0 μm.

wherein Tw is a transverse wall thickness, CD is a channel density, % P is an average bulk porosity, and d₅₀ is a median pore diameter; and a catalyst disposed in the first channels and the second channels.

In a further example embodiment, a method of manufacturing a honeycomb body comprises providing a honeycomb body comprising a plurality of intersecting porous walls arranged to form channels comprising first channels and second channels; and forming plugs in a percentage of the second channels to produce plugged channels, wherein greater than zero and less than or equal to 15% of the second channels are plugged channels.

Numerous other features and aspects are provided in accordance with these and other embodiments of the disclosure. Further features and aspects of embodiments will become more fully apparent from the following detailed description, the claims, and the accompanying drawings.

### BRIEF DESCRIPTION OF THE DRAWINGS

The accompanying drawings, described below, are for illustrative purposes and are not necessarily drawn to scale. The drawings are not intended to limit the scope of the disclosure in any way. Like numerals are used throughout the specification and drawings to denote like elements.

FIG. 1 illustrates a graphical representation of an amount of soot accumulated in a honeycomb body versus a total soot input for both an Asymmetric Cell (AC) honeycomb body and a non-asymmetric cell (non-AC) honeycomb body in accordance with this this disclosure.

FIG. 2 schematically illustrates a partial cross-sectional view of an example honeycomb body comprising some square channels with a hydraulic diameter less than the hydraulic diameter of other square channels, in accordance with this this disclosure.

FIG. 3 schematically illustrates a partial cross-sectional view of another example honeycomb body comprising some square channels with a hydraulic diameter less than the hydraulic diameter of other square channels, in accordance with this disclosure.

FIG. 4 schematically illustrates a partial cross-sectional view of another example honeycomb body comprising some square channels with a hydraulic diameter less than the hydraulic diameter of other octagonal channels, in accordance with this disclosure.

FIG. 5 schematically illustrates a partial cross-sectional view of another example honeycomb body comprising some square and rectangular channels with a hydraulic diameter less than the hydraulic diameter of other square channels, in accordance with this disclosure.

FIG. 6 schematically illustrates a partial cross-sectional view of another example honeycomb body comprising some rectangular channels with a hydraulic diameter less than the hydraulic diameter of other rectangular channels, in accordance with this disclosure.

FIG. 7 schematically illustrates a partial cross-sectional view of another example honeycomb body comprising some square channels with a hydraulic diameter less than the hydraulic diameter of other square channels, wherein the channels are arranged in rows along diagonals in accordance with this disclosure.

FIG. 8 schematically illustrates a partial cross-sectional view of another example honeycomb body comprising some triangular channels with a hydraulic diameter less than the hydraulic diameter of other hexagonal channels, in accordance with this disclosure.

FIG. 9 schematically illustrates an example outlet end of a partial honeycomb body comprising the cross-section of the honeycomb body shown in FIG. 4, with greater than zero and less than or equal to 15% of the smaller channels being plugged.

FIG. 10 illustrates a flow diagram of an example method of manufacturing a honeycomb body, in accordance with this disclosure.

### DETAILED DESCRIPTION

Reference will now be made in detail to the example embodiments of this disclosure, which are illustrated in the accompanying drawings. In describing the embodiments, numerous specific details are set forth in order to provide a thorough understanding of the disclosure. However, it will be apparent to a person skilled in the art that embodiments of the disclosure may be practiced without some or all of these specific details. Features of the various embodiments described herein may be combined with each other, unless specifically noted otherwise.

The materials, components, and assemblies described herein as making up the various embodiments are intended to be illustrative and not restrictive. Many suitable materials and components that would perform the same or a similar function as the materials and components described herein are intended to be embraced within the scope of embodiments of the present disclosure.

Various embodiments in accordance with this disclosure relate to honeycomb bodies suitable for use in the processing of automotive exhaust gases, and may comprise a catalyst provided in channels thereof. For example, in some embodiments, a honeycomb body can comprise intersecting porous walls that can be configured for use as a substrate for carrying a catalysts and promoting a catalyzing reaction with components of the exhaust gas flow. That is, the honeycomb body can comprise a substrate for deposit of a washcoat comprising one or more catalyst metals such as, but not limited to, platinum, palladium, rhodium, combinations thereof, or the like. These one or more metals catalyze at least one reaction between various components of the exhaust stream, such as of an exhaust stream from an internal combustion engine exhaust (e.g., automotive engine or diesel engine). Other metals may be added such as nickel and manganese to block sulfur absorption by the washcoat. A catalyzed reaction may include the oxidation of carbon monoxide to carbon dioxide, for example. Modern three-way catalytic converters may also reduce oxides of nitrogen (NOx) to nitrogen and oxygen. Additionally, the honeycomb body comprising a catalyst in accordance with this disclosure may facilitate the oxidation of unburnt hydrocarbons to carbon dioxide and water.

Treatment of exhaust gas from internal combustion engines may use catalysts supported on relatively high-surface area substrates of honeycomb bodies and, in the case of diesel engines and some gasoline engines, a catalyzed or uncatalyzed filter can be used for the removal of particles. Filters and catalyst supports in these applications preferably utilize materials that are refractory, thermal shock resistant, stable under a range of pO₂ conditions, non-reactive with the catalyst system, and offer low resistance to exhaust gas flow. Porous ceramic flow-through honeycomb bodies comprising honeycomb bodies and wall-flow honeycomb filters comprising partially plugged channels may be used in such applications.

In accordance with the disclosure, ceramic honeycomb body comprising a honeycomb structure may be made of an intersecting matrix of porous walls of a suitable porous material (e.g., porous ceramic). The catalytic material(s) may be suspended in a washcoat of, for example, inorganic particulates and a liquid vehicle. The washcoat may be disposed in the channels of the honeycomb substrate by, for example, coating. The washcoat may be disposed in some, or even all, of the channels and can comprise an on the wall coating, an in the wall coating, or both. In some embodiments, some of the channels can be plugged to form plugged channels. Thereafter, the catalyst coated porous ceramic honeycomb body (plugged or unplugged) may be wrapped with a cushioning material and received in a can (or housing) via a canning process.

Honeycomb bodies in accordance with the disclosure can be formed from a ceramic-forming batch mixture, for example, comprising ceramic-forming material that may comprise ceramic particulates or ceramic-forming precursor particulates, or both, a pore former, processing aids (e.g., methylcellulose and oil), liquid vehicle, and the like, and combinations thereof. The batch mixture can then be plasticized and formed into a green honeycomb body. When fired, the green honeycomb body formed from the ceramic-forming batch mixture is sintered into a porous ceramic material, for example, a porous ceramic suitable for exhaust treatment purposes. The ceramic composition of the ceramic honeycomb body may be cordierite, silicon carbide, silicon nitride, aluminum titanate, alumina, mullite, and the like, and combinations thereof.

The honeycomb body may be formed by an extrusion process wherein the plasticized ceramic-forming batch mixture is extruded into a green honeycomb body, which is then dried and fired to form the porous ceramic honeycomb body. The extrusion may be performed using a hydraulic ram extrusion press, a two stage de-airing single auger extruder, or twin-screw extruder, with an extrusion die attached to a discharge end thereof. Other suitable extruders or forming methods may be used.

Honeycomb extrusion dies employed to produce such honeycomb bodies may be multi-component assemblies including, for example, a wall-forming die body combined with a skin-forming mask. For example, U.S. Pat. Nos. 4,349,329 and 4,298,328 disclose extrusion dies including skin-forming masks. The die body may incorporate batch feedholes leading to, and intersecting with, an array of discharge slots formed in the die face, through which the ceramic-forming batch material is extruded. The extrusion forms an interconnecting matrix of crisscrossing walls (intersecting walls), forming a central cellular honeycomb body. A mask may be employed to form an outer peripheral skin, and the mask may be a ring-like circumferential structure, such as in the form of a collar, defining the periphery of the honeycomb body. The circumferential skin layer of the honeycomb body may be formed by extruding the batch material adjacent to the outer periphery of the walls of the honeycomb structure.

The extruded body, referred to as an extrudate, may be cut to create green honeycomb bodies. The extrudate can alternatively be in the form of a honeycomb segment, which may be connected or bonded together, such as after firing, with other fired honeycomb segments to form a final segmented honeycomb body. These honeycomb segments and resulting segmented honeycomb bodies may be of any suitable size or shape.

In some embodiments, the honeycomb body can comprise a diesel oxidation catalyst (DOC). DOC's are used to promote oxidation of carbon monoxide (CO), hydrocarbons (HC) as well as the soluble organic fraction (SOF) of diesel exhaust. As used herein, DOC refers to a ceramic honeycomb body comprising a catalytic coating. The catalyst coating can be provided in, on, or both of at least a portion of the interior porous walls of the porous ceramic honeycomb body. Embodiments in accordance with the present disclosure are also suitable for use with three-way catalyst, i.e., catalysts configured for reactions with CO, HC, and NOx.

As used in vehicles, the DOC can plays a role in the controlled regeneration of particulate matter in a diesel particulate filter (DPF) downstream of the DOC. The diesel particulate filter collects soot particles over time, and eventually needs to be regenerated. Regeneration of the diesel particulate filter is accomplished either in a passive mode, where the exhaust temperatures become high enough to promote oxidation of the soot, or in an active mode where fuel is injected into the exhaust to be oxidized in the DOC and raise the inlet temperature of the gas entering the DPF so that regeneration may occur.

In many cases, space for the DOC and DPF is limited on vehicles. Therefore, DOC and DPF designs that reduce the space envelope required for these devices are sought after. A constraint on reducing size, as well as reducing catalyst loading, is the desire for a relatively high reaction rate of the effluent with the catalyst disposed in the channels of the ceramic honeycomb (e.g., DOC). Larger honeycomb body sizes and high catalyst loading can potentially provide the relatively high reaction rate, but can appreciably increase the cost of the after-treatment system, i.e., of the DOC. Substantial cost savings in the form of precious metals and honeycomb body size may be achieved in accordance with one aspect of the present disclosure by increasing the reaction rate with the effluent at the porous walls where the catalyst is located. The conversion rate is controlled by transport limitations i.e., the gas has to contact the surface of the catalyst. With respect to the DOC, one solution for reducing the size of the honeycomb bodies is by increasing the conversion efficiency, i.e., percentage of the component removed from the effluent flow.

The honeycomb body configurations disclosed herein can increase flow through the porous walls of honeycomb body, thereby increasing the contact between the exhaust gas and the catalyst, and thus increasing the relative conversion efficiency. In addition, embodiments can provide a reduced size for the DOC, improved conversion efficiency at the same size, and/or combinations of reduced size and improved conversion efficiency. Various embodiments in accordance with this disclosure may also reduce the amount of catalyst (e.g., noble metal catalysts) coating the walls of the honeycomb body in view of the decreased size of the DOC. Reduced size and catalyst usage can contribute to reduced cost.

Various embodiments in accordance with the present disclosure provide either a unplugged flow-through honeycomb body containing channels of more than one hydraulic diameter that are catalyzed, or plugged honeycomb bodies, wherein a small percentage of the smaller channels are plugged. Differences in the hydraulic diameters of neighboring channels may result in a difference in the gas velocities in these neighboring channels. If a wall separating neighboring channels is sufficiently permeable, then a difference in gas velocities between the neighboring channels will impart a pressure differential across the wall, for example due to the Bernoulli effect. This pressure differential enables gas flow to pass through the wall where the catalyst resides, which provides increased convergence efficiency due to increased contact between the exhaust gas and catalyst.

To demonstrate the increased gas flow through the permeable porous walls from the small hydraulic diameter channels into the larger hydraulic diameter channels, an experiment was conducted. Using soot accumulation as a proxy for gas flow, the inventors discovered that there is a difference in soot-loading capability for unplugged honeycomb bodies that have different channel designs, i.e., combinations of larger and smaller channels.

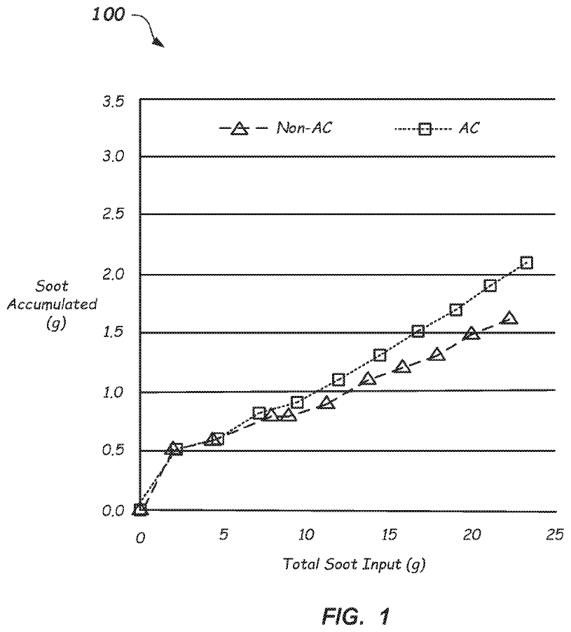

FIG. 1 shows a graph 100 of an amount of soot accumulated (in grams) in a honeycomb body (vertical axis) as a function of a total soot input (in grams—horizontal axis) for both an AC honeycomb body (small dashes) and a non-AC honeycomb body (large dashes). In this experiment, both the AC honeycomb body and the non-AC honeycomb body were 14.4 cm in diameter, 15.2 cm in length, had a cell density (CD) of 42.6 channels per cm², and a transverse wall thickness (Tw) of 0.20 mm. Both honeycomb bodies were made from the same cordierite material that had a high permeability (approx. 65% average bulk porosity). The AC honeycomb body has a combination of larger channels and smaller channels of large and small cross-sectional channels, respectively, disbursed across the honeycomb body. Thus the large and small channels comprise differing hydraulic areas. The non-AC honeycomb body comprises all channels of the same cross-sectional area and thus the same hydraulic area.

For this experiment, the exhaust stream used was soot laden. As described above, the amount of accumulated soot was used as a proxy for the gas flow through the porous walls. As can be seen in FIG. 1, the soot accumulation for the AC honeycomb body is significantly higher than the soot accumulation for non-AC honeycomb body, wherein both are unplugged bodies. Thus, it was demonstrated that there was greater gas flow through the walls due to the presence of both small hydraulic diameter channels and larger hydraulic diameter channels in the flow-through honeycomb body.

In various embodiments in accordance with this disclosure, a flow-through honeycomb body is provided that comprises a plurality of first channels having a first hydraulic diameter, and a plurality of second channels having a second hydraulic diameter that is smaller than the first hydraulic diameter. Some embodiments may be unplugged and comprise a catalyst disposed in the channels. For example, the AC honeycomb body configuration can be used for carrying a TWC for a DOC application.

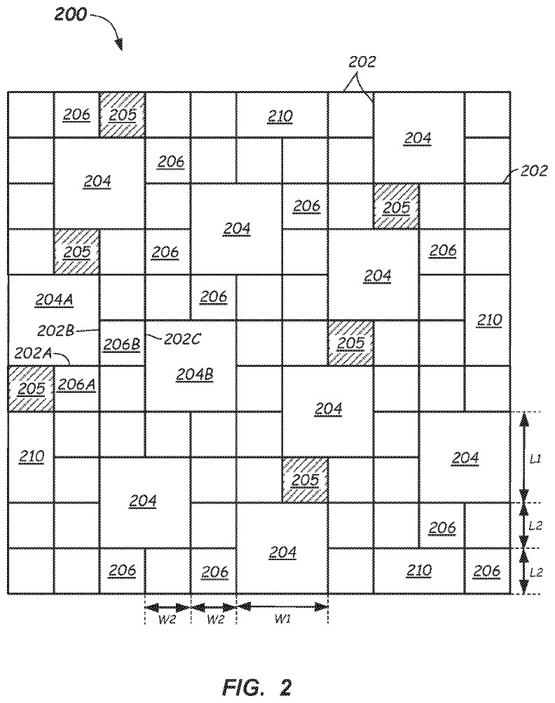

In other embodiments, portions of at least some of the second channels may be plugged, such as proximate an outlet end of the honeycomb body (described below). FIGS. 2-8 illustrate several examples of honeycomb body arrangements that may be used in plugged and unplugged embodiments in accordance with this disclosure.

FIG. 2 illustrates a partial cross-sectional view of an example honeycomb body 200 comprising some channels with a hydraulic diameter less than the hydraulic diameter of other channels, in accordance with this disclosure. The honeycomb body 200 comprises a plurality of intersecting porous walls 202 forming a plurality of four-sided first channels 204 (a few labeled) having a first hydraulic diameter (e.g., larger hydraulic area) and a plurality of four-sided second channels 206 (a few labeled) having a second hydraulic diameter (e.g., relatively smaller hydraulic area). The present embodiment comprises larger and smaller squares in transverse cross section. However, various embodiments are not limited to four-sided channels.

In this example embodiment, each of the second channels 206 has a width W2 and a length L2. Each of the first channels 204 has a width of W1 and a length of L1. In this example embodiment, W2 and L2 are both equal to one unit of length. Thus, each first channel 204 and each second channel 206 can comprise a square cross-sectional area. In this example embodiment, each first channel 204 has a hydraulic diameter, and each second channel 206 has a hydraulic diameter. An approximation for the hydraulic diameter of a square channel is 4A/P, where A is the transverse cross-sectional area of the channel, and P is the inside perimeter length of the channel. Thus, the hydraulic diameter of the second channels 206 is smaller than the hydraulic diameter of the first channels 206, and a ratio (hydraulic diameter ratio or HDR) of the first hydraulic diameter to the second hydraulic diameter is greater than 1.0. In some embodiments the ratio of the first hydraulic diameter to the second hydraulic diameter (i.e., HDR=first hydraulic diameter/second hydraulic diameter) may be in the range from 1.2 to 2.0. In other embodiments, HDR may be in the range from 1.3 to 1.6.

In various embodiments, a percentage of the second (smaller) channels 206 are plugged at one end of the honeycomb body 200 (see FIGS. 2-3 and 5-9).

In the arrangement of channels shown in FIG. 2, each second channel 206 shares a common wall with at least one first channel 204, and a portion of the second channels 206 share two common walls respectively with two different first channels 204. For example, a second channel 206A may comprise a wall 202A shared with a first channel 204A. In addition, a second channel 206B may comprise a wall 202B and a wall 202C. The second channel 206B may share the wall 202B with the first channel 204A and the second channel 206B may share the wall 202C with a first channel 204B. If the honeycomb body 200 comprises plugs 205, then the plugs 205 can be located in second channels 206 that comprise two shared walls with the first channels 204. FIG. 2 is shown with plugs 205 in a percentage of the smaller second channels 206. If plugged, then the percentage of the second channels 206 with plugs comprising plugged channels should be greater than zero and less than or equal to 15%. This allows for minimized backpressure, while allowing for enhanced soot capture in the plugged honeycomb body 200. Although shown with plugs 205, the honeycomb body 200 may optionally be unplugged wherein the percentage of plugs 205 is zero and the channels (first channels 204 and second channels 206) each have a catalyst disposed therein. Plugs 205 as well as other plugs as otherwise referred to herein can be formed by any suitable plug forming method, such as disclosed in U.S. Pat. Nos. 4,411,856, 4,427,728, 4,557,682, 4,557,773, and 7,922,951, for example.

Because the illustration of FIG. 2 represents a partial view of an entire honeycomb body 200, this illustration also shows partial second channels 210. It will be understood that the portion of the honeycomb body 200 shown in FIG. 2 may be extended in a repeating pattern to produce a honeycomb body 200 of an arbitrary size, in accordance with this disclosure.

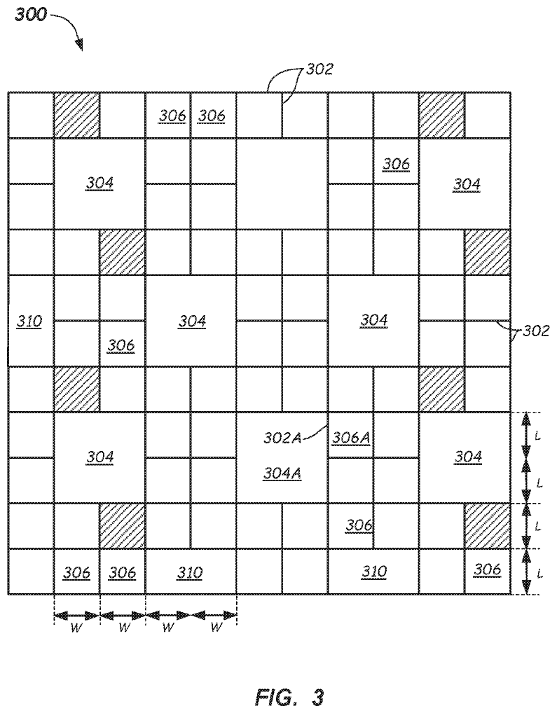

FIG. 3 illustrates a partial cross-sectional view of another example honeycomb body 300 comprising some channels with a hydraulic diameter less than the hydraulic diameter of other channels, in accordance with this disclosure. The honeycomb body 300 comprises a plurality of porous walls 302 forming a plurality of four-sided first channels 304 and a plurality of four-sided second channels 306, wherein the second channels 306 are smaller in cross sectional area than the first channels 304. Various embodiments are not limited to four-sided channels. Each first channel 304 may have a first hydraulic diameter, and each second channel 306 may have a second hydraulic diameter that is smaller than the first hydraulic diameter. Each second channel 304 shares a common wall with one first channel 304, and none of the second channels 304 share more than one common wall with any first channel 302.

For example, reference is made to a first channel 304A, which is representative of all the first channels 304 and second channel 306A, which is representative of all the second channels 306. The second channel 306A shares a single wall 302A with the first channel 30A. The second channel 306A does not share any other walls with any other first channels 304. If plugs 305 are present, then plugs 305 may be included where a wall 302 between the first channel 304 and the second channel 306 are shared. If plugged, then the percentage of the second channels 306 with plugs 305 comprising plugged channels should be greater than zero and less than or equal to 15%. Although shown with plugs 305, the honeycomb body 200 may optionally be unplugged wherein the percentage of plugs 205 is zero and the channels (first channels 304 and second channels 306) each have a catalyst disposed therein.

In the arrangement illustrated in FIG. 3, only a portion of a complete honeycomb is shown. Thus, along the left edge and the bottom edge, partial first channels 310 are shown. This is simply an artifact of showing a partial structure of a repeating pattern.

Still referring to FIG. 3, the HDR of the first hydraulic diameter to the second hydraulic diameter may be in the range from 1.2 to 2.0. Alternatively, the HDR for the honeycomb body 300 may in the range from 1.3 to 1.6.

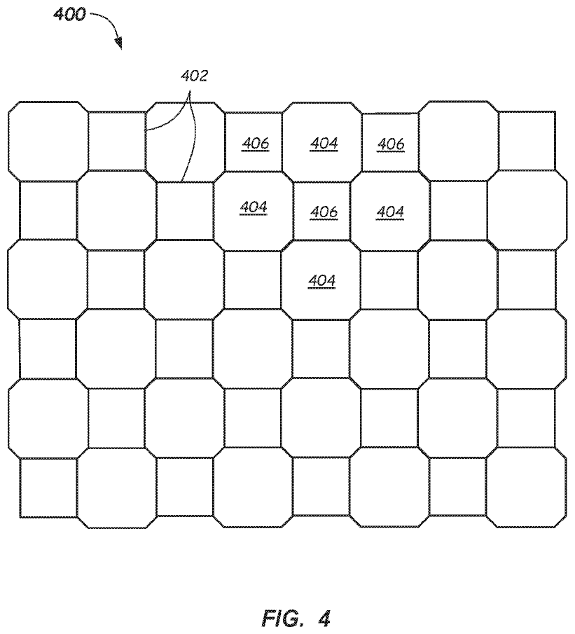

FIG. 4 illustrates a partial cross-section of another example honeycomb body 400 having some channels with a hydraulic diameter less than the hydraulic diameter of other channels, in accordance with this disclosure. In this AC configuration having a matrix of larger channels 404 (a few labeled) and smaller channels 406 (a few labeled), honeycomb body 400 comprises a first plurality of first channels 404 comprising octagonal channels having a first hydraulic diameter, and a second plurality of second channels 406 comprising square channels having a second hydraulic diameter that is less than the first hydraulic diameter. In this AC configuration, the walls 402 of the first and second channels are highly porous, having an average bulk porosity (% P) wherein % P≥50%. A first channel 404 shares a respective common wall with each of four second channels 406, and further shares a respective common wall with each of four other first channels 404. Each second channel 406 shares a respective common wall with each of four first channels 404. In this embodiment, the honeycomb body 400 is unplugged, i.e., the percentage of plugged channels is zero, and the walls 402 comprise a catalyst disposed in the channels (first channels 404 and second channels 406) as an in the wall or on the wall configuration, or both. For the TWC application, the catalyst coating can be predominantly included in the pores of the walls as an in the wall coating. To facilitate good washcoat penetration and to further promote good through the wall gas flow, the porous walls 402 of the honeycomb body 400 should have properties of:
Tw≤0.20 mm,
CD≥62 channels per cm²,
% P≥50%, and
4.0 μm≤d₅₀≤30.0 μm,

wherein Tw is a transverse wall thickness, CD is a channel density, % P is an average bulk porosity, and d₅₀ is a median pore diameter.

Still referring to FIG. 4, the HDR of the first hydraulic diameter to the second hydraulic diameter may be in the range of from 1.2 to 2.0. Alternatively, the HDR for the AC configuration of honeycomb body 400 may be in the range of 1.3 to 1.6.

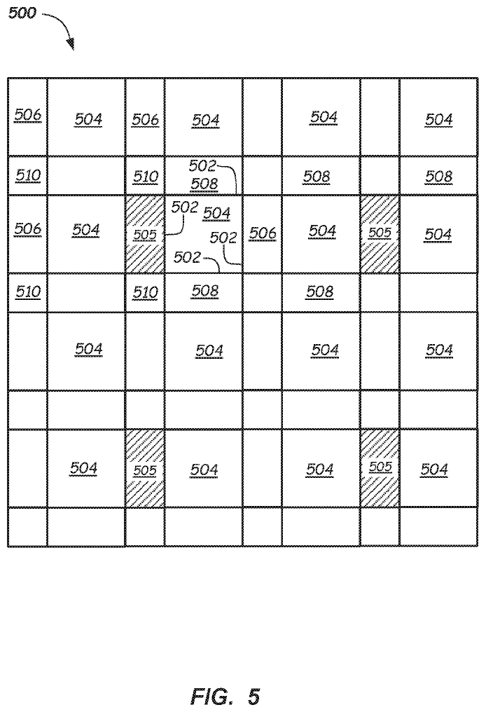

FIG. 5 illustrates a partial cross-section of another example honeycomb body 500 having some channels with a hydraulic diameter less than the hydraulic diameter of other channels, in accordance with this disclosure. Each four-sided channel in FIG. 5 is defined by intersecting porous walls 502. Honeycomb body 500 provides a plurality of first channels 504 (a few labeled) having a first hydraulic diameter, a plurality of second channels 506 (a few labeled) having a second hydraulic diameter, a plurality of third channels 508 (a few labeled) having the second hydraulic diameter, and a plurality of fourth channels 510 (a few labeled) having a third hydraulic diameter. In this example embodiment, the second hydraulic diameter is smaller than the first hydraulic diameter. The third hydraulic diameter is also smaller than the first hydraulic diameter, and the third hydraulic diameter is smaller than the second hydraulic diameter.

In honeycomb body 500, the first channel 504 is defined by intersecting porous walls 502. First channel 504 has, as shown, a pair of opposing vertically-oriented walls 502 that are shared in common with a corresponding pair of second channels 506. Similarly, first channel 504 has, as shown, a pair of opposing horizontally-oriented walls 502 that are shared in common with a corresponding pair of third channels 508. A second channel 506 is defined by intersecting walls 502. Second channel 506 has a pair of vertically-oriented walls 502 that are shared in common with a corresponding pair of first channels 504. Similarly, second channel 506 has a pair of opposing horizontally-oriented walls 502 that are shared with a corresponding pair of fourth channels 510. The third channel 508 is defined by intersecting walls 502. Third channel 508 has pair of opposing vertically-oriented walls 502 that are shared in common with a corresponding pair of fourth channels 510. Similarly, third channel 508 has a pair of opposing horizontally-oriented walls 502 that are shared with a corresponding pair of first channels 504.

Still referring to FIG. 5, the HDR of the first hydraulic diameter to the second hydraulic diameter may be in the range of 1.2 to 2.0. Alternatively, the HDR for the honeycomb body 500 may be in the range from 1.3 to 1.6. In some embodiments, a percentage of the channels, with a hydraulic diameter smaller than the hydraulic diameter of the first channels 504, can be plugged with a plug 505 at one end of the honeycomb body 500. For example, some channels 506 may be plugged that share a walls 502 with the first channels 504. Optionally, some of the third channels 508 may be plugged.

If plugged, then the percentage of the smaller channels (second channels 506 plus third channels 508 plus fourth channels 510) with plugs 505 comprising plugged channels should be greater than zero and less than or equal to 15%. Although shown with plugs 505, the honeycomb body 500 may optionally be unplugged wherein the percentage of plugs 505 is zero and all the channels (first channels 504, second channels 506, third channels 508, and fourth channels 510) each have a catalyst disposed therein.

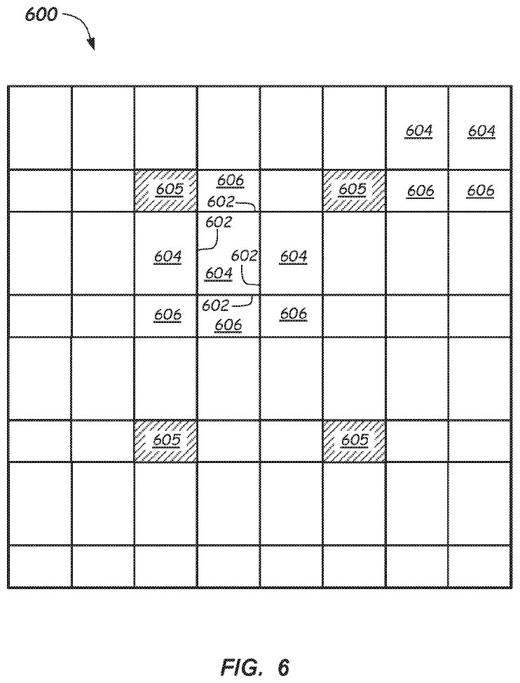

FIG. 6 illustrates a partial cross-section of another example honeycomb body 600 having some channels with a hydraulic diameter less than the hydraulic diameter of other channels, in accordance with this disclosure. Each four-sided channel in FIG. 6 is defined by intersecting porous walls 602. Honeycomb body 600 provides a plurality of first channels 604 having a first hydraulic diameter, and a plurality of second channels 606 having a second hydraulic diameter. The second hydraulic diameter is smaller than the first hydraulic diameter.

In honeycomb body 600, a first channel 604 is defined by intersecting porous walls 602. As shown, first channel 604 has pair of opposing vertically-oriented walls 602 that are shared in common with a corresponding pair of other first channels 604. Similarly, first channel 604 has a pair of opposing horizontally-oriented walls 602 that are shared in common with a corresponding pair of second channels 606. A second channel 606 is also defined by intersecting walls 602. Second channel 606 has a pair of vertically-oriented walls 602 that are shared in common with a corresponding pair of other second channels 606. Similarly, second channel 606 has a pair of opposing horizontally-oriented walls 602 that are shared with a corresponding pair of first channels 604.

Still referring to FIG. 6, the HDR of the first hydraulic diameter to the second hydraulic diameter may be in the range of from 1.2 to 2.0. Alternatively, the HDR for the honeycomb body 600 may be in the range from 1.3 to 1.6. In some embodiments, a percentage of the second channels 606 are plugged with plugs 605 at one end of the honeycomb body 600, such as at the outlet end (downstream end in use). If plugged, then the percentage of the second channels 606 with plugs 605 comprising plugged channels should be greater than zero and less than or equal to 15%. Although shown with plugs 605, the honeycomb body 600 may optionally be unplugged wherein the percentage of plugs 605 is zero and all the channels (first channels 604 and second channels 606) each have a catalyst disposed therein.

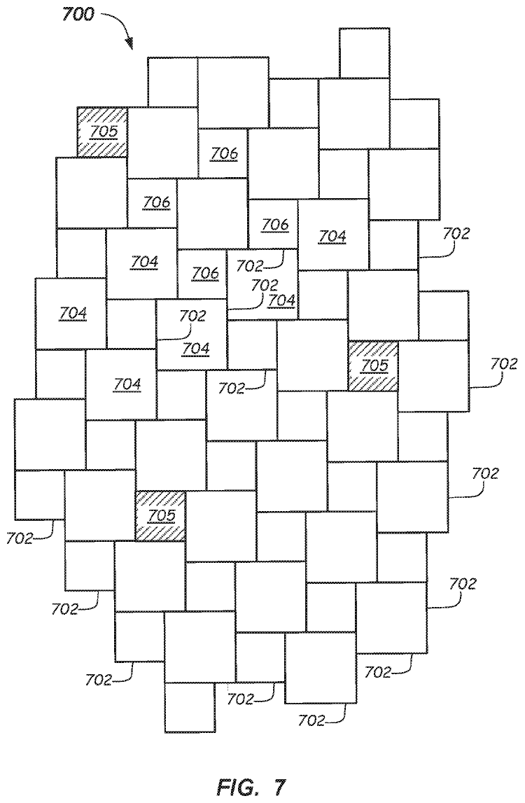

FIG. 7 illustrates a partial cross-section of another example honeycomb body 700 having some channels with a hydraulic diameter less than the hydraulic diameter of other channels, in accordance with this disclosure. A plurality of porous walls 702 defines a plurality of four-sided first channels 704 and a plurality of four-sided second channels 706. First channels 704 each have a first hydraulic diameter, and second channels 706 each have a second hydraulic diameter. The second hydraulic diameter is smaller than the first hydraulic diameter.

In the honeycomb body 700, a first channel 704 is defined by intersecting walls 702, which are porous. First channel 704 (shown as large squares in FIG. 7) has, as shown, a pair of opposing vertically-oriented walls 702, first portions of which are shared in common with a respective first corresponding pair of other first channels 704, and second portions of which are shared in common with, respectively, a first corresponding pair of second channels 706. First channel 704 has a pair of opposing horizontally-oriented walls 702, first portions of which are shared in common with a second corresponding pair of other first channels 704, and second portions of which are shared in common with a second corresponding pair of second channels 706. The second channels 706 are also defined by intersecting walls 702. Second channels 706 (shown as small squares in FIG. 7) have, as shown, a pair of opposing vertically-oriented walls 702 that are shared in common, respectively, with a portion of each of a first corresponding pair of first channels 704. Second channels 706 also comprise, as shown, a pair of opposing, horizontally-oriented walls 702 that are shared in common, respectively, with a portion of each of a second corresponding pair of first channels 704.

Still referring to FIG. 7, the HDR of the first hydraulic diameter to the second hydraulic diameter may be in the range of 1.2 to 2.0. Alternatively, HDR of the first hydraulic diameter to the second hydraulic diameter for the honeycomb body 700 may range from 1.3 to 1.6. In some embodiments, a percentage of the second channels 706 are plugged with plugs 705 at one end of the honeycomb body 700, such as at the outlet end. If plugged, then the percentage of the second channels 706 with plugs 705 comprising plugged channels should be greater than zero and less than or equal to 15%. Although shown with plugs 705, the honeycomb body 700 may optionally be unplugged wherein the percentage of plugs 705 is zero and all the channels (first channels 704 and second channels 706) each have a catalyst disposed therein.

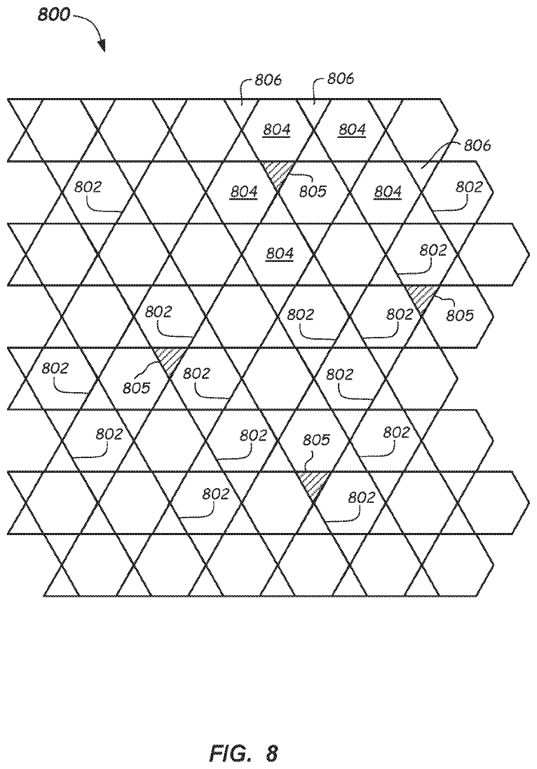

FIG. 8 illustrates a partial cross-section of another example honeycomb body 800 having some channels with a hydraulic diameter smaller than the hydraulic diameter of other channels, in accordance with this disclosure. A plurality of intersecting porous walls 802 defines a plurality of six-sided (hexagonal) first channels 804 (a few labeled), and a plurality of three-sided (triangular) second channels 806 (a few labeled). First channels 804 each have a first hydraulic diameter, and second channels 806 each have a second hydraulic diameter. In various embodiments, the second hydraulic diameter is smaller than the first hydraulic diameter.

In example honeycomb body 800, each side of the six-sided first channel 804 is shared in common with a corresponding one of the six three-sided channels 806. Further, each side of a three-sided second channel 806 is shared in common with a corresponding one of the six-sided first channels 804.

Still referring to FIG. 8, the HDR of the first hydraulic diameter to the second hydraulic diameter may be in the range of 1.2 to 2.0. Alternatively, the HDR for the honeycomb body 800 may range from 1.3 to 1.6. In some embodiments, a percentage of the second channels 806 are plugged with plugs 805 at one end of the honeycomb body 800, such as at the outlet end. If plugged, then the percentage of the second channels 806 with plugs 805 comprising plugged channels should be greater than zero and less than or equal to 15%. Although shown with plugs 805, the honeycomb body 800 may optionally be unplugged wherein the percentage of plugs 805 is zero and all the channels (first channels 804 and second channels 806) each have a catalyst disposed therein.

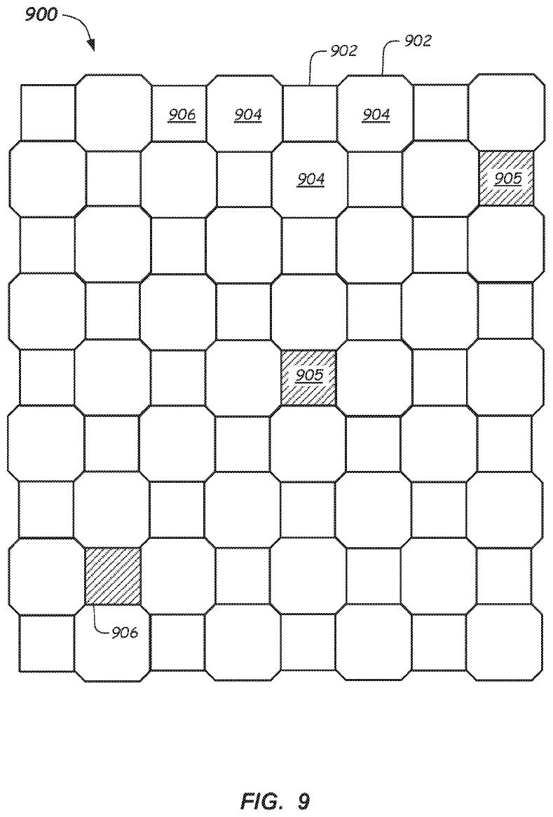

FIG. 9 illustrates an example outlet end of an AC configuration of a honeycomb body 900, with greater than zero and less than or equal to 15% of the second channels 906 (smaller channels) being plugged with plugs 905. The length of the honeycomb body 900 refers to its length from one end to the other. A first such end may be designated as an inlet end, and the other end may be designated as an outlet end.

Honeycomb body 900 comprises an AC configuration comprising alternating first channels 904 and second channels 906. First channels 904 each have a first hydraulic diameter, and second channels 906 each have a second hydraulic diameter, which is smaller than the first hydraulic diameter. As shown in FIG. 9, plugs 905 have been disposed proximate the outlet end of honeycomb body 900. In accordance with this disclosure, the plugs 905 have been disposed in a non-zero percentage of, but not all of, the second channels 906. That is, in this example embodiment, the plugs 905 are placed in a percentage of the channels that have a smaller hydraulic diameter, wherein the percentage is greater than zero and less than or equal to 15%.

Table 1, below, shows the relationship between HDR and the fraction of small hydraulic diameter channels (e.g., second channels) that are plugged, to the pressure drop across a honeycomb body (described below) and the percentage of flow through the porous walls of the honeycomb body.

TABLE 1

| | Percentage of | Pressure | % of Flow Through |
|---|---|---|---|
| HDR | Plugged Channels | Drop (kPa) | Walls |
| 1 | 1% | 0.4543 | 0.9748 |
| 1 | 2% | 0.4544 | 0.195 |
| 1 | 4% | 0.4546 | 3.9 |
| 1 | 8% | 0.4549 | 7.8 |
| 1 | 15% | 0.4556 | 14.67 |
| 1.3 | 1% | 0.523 | 0.98 |
| 1.3 | 2% | 0.5234 | 1.96 |
| 1.3 | 4% | 0.5236 | 3.93 |
| 1.3 | 8% | 0.5240 | 7.86 |
| 1.3 | 15% | 0.5246 | 14.75 |
| 1.6 | 1% | 0.701 | 0.99 |
| 1.6 | 2% | 0.701 | 1.98 |
| 1.6 | 4% | 0.7015 | 3.95 |
| 1.6 | 8% | 0.7019 | 7.91 |
| 1.6 | 15% | 0.7024 | 14.84 |

Table 1 shows different HDRs and plugging fractions for a honeycomb body that is 11.8 cm in diameter, 10.2 cm in length, having a wall thickness of 0.05 mm, 93 channels per cm², a wall average bulk porosity of 50%, and a wall median pore diameter of 19 μm. The pressure drop and fraction of flow through the walls has been calculated for a gas mass flow rate of 50 kg/hr and gas temperature of 450° C.

Since plugging of the honeycomb body increases the pressure drop across the honeycomb body, in various embodiments the percentage of second channels comprising plugs may be less than or equal to 15%, in other embodiments less than or equal to 12%, and in still other embodiments less than or equal to 10%.

With respect to the example honeycomb body configurations shown in FIGS. 2-3 and 5-9, in various embodiments, the percentage of second channels comprising plugs may be greater than 2%, in other embodiments greater than 4%, and in still other embodiments, greater than 5%. In other embodiments, the percentage can be greater than 2% and less than or equal to 15%, or even can be greater than 2% and less than or equal to 12%. In some embodiments, the average bulk porosity % P can be greater than or equal to 50%, greater than or equal to 55%, greater than or equal to 60%, or even greater than or equal to 65% in some embodiments. In some embodiments, the average bulk porosity % P can be greater than or equal to 50% and less than or equal to 70%.

In some embodiments, the channel density CD may be greater than or equal to 62 channels per cm², in other embodiments greater than 93 channels per cm², and in still other embodiments greater than 124 channels per cm². In some embodiments, the wall thickness Tw can be less than or equal to 0.20 mm, in other embodiments less than 0.15 mm, and in still further embodiments less than 0.10 mm.

In some embodiments, the median pore diameter may be between 4.0 μm and 30.0 μm, or even between 7.0 μm and 20.0 μm. The ceramic honeycomb body should also exhibit a coefficient of thermal expansion (CTE) that is suitably low to enable suitable thermal shock resistance for the particular application. For example, a CTE of the honeycomb body can be less than or equal to 20.0×10⁻⁷/° C. measured form 25° C. to 800° C., or even less than or equal to 15.0×10⁻⁷/° C. measured form 25° C. to 800° C.

For the AC configurations, the HDR can be between 1.2 and 2.0 and even between 1.3 and 1.6 in some embodiments. Higher HDR results in higher percentages of flow through the wall as compared to lower HDR. Thus additional soot can be captured. Production of the desired wall thickness Tw and channel density CD can be through selection and use of the appropriate extrusion die for each configuration. The production of the desired average bulk porosity % P and median pore size can be through selection of suitably sized ceramic-forming raw materials and amounts and sizes of pore formers in the batch mixture. Cordierite-containing materials exhibiting the combination of the above-listed properties have been found to be well adapted to use as TWC substrates and partial filters including TWC.

In some example embodiments, the honeycomb body comprises a percentage of the second channels that comprise plugs greater than 2% and less than or equal to 15%, an average bulk porosity % P of greater than 50%, a channel density CD greater than or equal to 62 channels per cm², a wall thickness Tw of less than or equal to 0.20 mm, a median pore diameter between 4.0 μm and 30.0 μm, and HDR between 1.2 and 2.0.

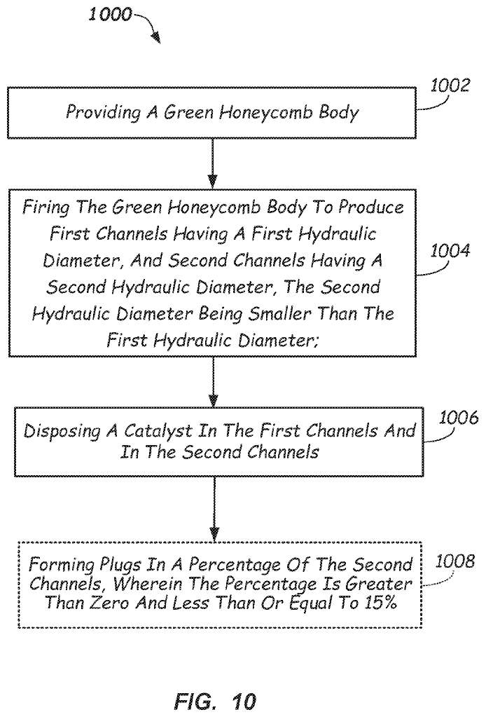

FIG. 10 illustrates a flow diagram of an example method 1000 of manufacturing a honeycomb body, in accordance with this disclosure. At a block 1002, method 1000 provides a green honeycomb body. In some embodiments, the green honeycomb body is formed by extruding a ceramic-forming batch mixture through an extrusion die. At a block 1004, method 1000 comprises firing the green honeycomb body to produce first channels having a first hydraulic diameter, and second channels having a second hydraulic diameter, wherein the second hydraulic diameter is smaller than the first hydraulic diameter. Generally, firing will not appreciably change the HDR ratio, even though there may be some shrinkage due to firing. The ceramic honeycomb body formed by the firing may be made of any suitable material comprising, but not limited to, cordierite, silicon carbide, silicon nitride, aluminum titanate, alumina, mullite, or the like, and combinations thereof.

At a block 1006, method 1000 disposes a catalyst in the first channels and in the second channels. Disposing the catalyst in the first channels and the second channels may comprise coating the honeycomb body with a catalyst-containing washcoat. Such a washcoat may comprise, for example, one or more metals such as, but not limited to, platinum, palladium, rhodium, combinations thereof, or the like. The first channels and the second channels may comprise an on the wall coating, in the wall coating, or both. The catalyst-containing coating may be a TWC coating an oxidation catalyst, a NOx reducing catalyst such as an SCR catalyst, a SOx catalysts, and the like. For TWC coating, the washcoat may be disposed in the channels (in both the larger and smaller channels) as a predominantly in the wall coating. The catalyst coating may be applied to the channels by any suitable method, such as dipping. The catalyst coatings may be applied after plugging in honeycomb bodies wherein the bodies comprise the small percentage (≤15%) of plugged smaller channels.

At a block 1008, the method 1000 comprises forming plugs in a percentage of the second channels, i.e., the channels having the smaller hydraulic diameter.

The acronym “AC” refers to asymmetric cell.

The acronym “DOC” refers to diesel oxidation catalyst.

The acronym “DPF” refers to diesel particulate filter.

The term “hydraulic diameter” refers to a parameter used to express fluid flow characteristics and pressure drop characteristics of non-circular channels in terms of their circular equivalents. The general formula for determining hydraulic diameter is D_{H}=4A/P, where D_{H} is the hydraulic diameter, A is the flow cross-sectional area of the channel, and P is the wetted perimeter of the channel.

Thus, for a second channel 206 being a square, the hydraulic diameter is equal to 2×W2×L2/W2+L2, where W2 is the width, and L2 is the length of the second channel 206 (see FIG. 2). For the first channel 204 being a square, the hydraulic diameter is equal to 2×W1×L1/W1+L1, where W1 is the width, and L1 is the length of the first channel 206 in a honeycomb body 200. Hydraulic diameters for other shapes disclosed herein can be calculated using the above general formula D_{H}=4A/P.

Although the terms first, second, etc., may be used herein to describe various elements, components, regions, parts or sections, these elements, components, regions, parts or sections, should not be limited by these terms. The terms may be used to distinguish one element, component, region, part or section, from another element, component, region, part or section. For example, a first element, component, region, part or section discussed above could be termed a second element, component, region, part or section without departing from the teachings of the present disclosure.

While embodiments of this disclosure have been disclosed in example forms, many modifications, additions, and deletions can be made therein without departing from the scope of this disclosure, as set forth in the claims and their equivalents.

1. A honeycomb body comprising:
a matrix of intersecting porous walls forming first channels and second channels arranged with a channel density (CD), and
plugs disposed in a percentage of the second channels, wherein the percentage of the second channels with plugs is greater than zero and less than or equal to 15%, wherein the intersecting porous walls have a transverse wall thickness (Tw), an average bulk porosity (% P), and a median pore diameter (d₅₀), wherein:
Tw≤0.20 mm,
CD≥62 channels per cm²,
% P≥50%, and
4.0 μm≤d₅₀≤30.0 μm.

2. The honeycomb body of claim 1 wherein the first channels comprise a first hydraulic diameter and the second channels comprise a second hydraulic diameter, the second hydraulic diameter being smaller than the first hydraulic diameter.

3. The honeycomb body of claim 2 wherein the percentage of the second channels with plugs is less than or equal to 12%.

4. The honeycomb body of claim 3 wherein the percentage of the second channels with plugs is less than or equal to 10%.

5. The honeycomb body of claim 2 wherein the percentage of the second channels with plugs ranges from 0.5% to 15%.

6. The honeycomb body of claim 5 wherein the percentage of the second channels with plugs ranges from 2% to 15%.

7. The honeycomb body of claim 5 wherein the percentage of the second channels with plugs ranges from 4% to 15%.

8. The honeycomb body of claim 5 wherein the percentage of the second channels with plugs ranges from 5% to 15%.

9. The honeycomb body of claim 5 wherein the percentage of the second channels with plugs ranges from 2% to 12%.

10. The honeycomb body of claim 1 wherein CD≥93 cells per cm².

11. The honeycomb body of claim 10 wherein CD≥124 cells per cm².

12. The honeycomb body of claim 1 wherein Tw≤0.15 mm.

13. The honeycomb body of claim 12 wherein Tw≤0.10 mm.

14. The honeycomb body of claim 1 wherein the first channels comprise a first hydraulic diameter and the second channels comprise a second hydraulic diameter, the second hydraulic diameter being smaller than the first hydraulic diameter, and wherein a ratio of the first hydraulic diameter divided by the second hydraulic diameter ranges from 1.2 to 2.0.

15. The honeycomb body of claim 14 wherein a ratio of the first hydraulic diameter to the second hydraulic diameter ranges from 1.3 to 1.6.

16. The honeycomb body of claim 1 wherein the honeycomb body comprises an outlet end, and the plugs in the second channels are located proximate the outlet end.

17. A catalytic honeycomb body comprising:
a matrix of intersecting porous walls forming first channels and second channels, each first channel having a first hydraulic diameter, and each second channel having a second hydraulic diameter, wherein the second hydraulic diameter is smaller than the first hydraulic diameter; and
plugs disposed in a percentage of the second channels at an outlet end, the percentage of the second channels with plugs is greater than zero and less than or equal to 15%;
and
a catalyst disposed on the porous walls of the first channels and the second channels;
wherein the intersecting porous walls have a transverse wall thickness (Tw), a channel density (CD), an average bulk porosity (% P), and a median pore diameter (d₅₀), wherein:
Tw≤0.20 mm,
CD≥62 channels per cm²,
% P≥50%, and
4.0 μm≤d₅₀≤30.0 μm.

18. A catalytic honeycomb body comprising:
a matrix of intersecting porous walls forming first channels and second channels, wherein each first channel comprises a first hydraulic diameter, and each second channel comprises a second hydraulic diameter, wherein the second hydraulic diameter is smaller than the first hydraulic diameter; and
plugs disposed in a percentage of the second channels, the percentage of the second channels with plugs is less than or equal to 15%; and
a catalyst disposed in the first channels and the second channels;
wherein the intersecting porous walls have a transverse wall thickness (Tw), a channel density (CD), an average bulk porosity (% P), and a median pore diameter (d₅₀), wherein:
Tw≤0.20 mm,
CD≥62 channels per cm²,
% P≥50%, and
4.0 μm≤d₅₀≤30.0 μm.

19. (canceled)

20. (canceled)

21. (canceled)

22. (canceled)
